(19) United States
(12) Patent Application Publication
(10) Pub. No.: US 2006/0098950 A1
(43) Pub. Date: May 11, 2006

(54) Digital video recording device

(75) Inventors: Yasunori Naruse, Kusatsu-shi (JP); Takushi Okamoto, Takatsuki-shi (JP)

Correspondence Address: MCDERMOTT WILL & EMERY LLP, 600 13TH STREET, N.W., WASHINGTON, DC, 20005-3096, US

(73) Assignee: Matsushita Electric Industrial Co., Ltd.

(21) Appl. No.: 11/270,603

(22) Filed: Nov. 10, 2005

(30) Foreign Application Priority Data
Nov. 11, 2004 (JP) 2004-327914

(51) Int. Cl. H04N 5/781

(52) U.S. Cl. 386/98; 386/111; 386/125

(57) ABSTRACT

It is a digital video recording device which comprises: an encoding unit which generates bitstream data by performing encoding processing on recording-target video/audio signals and outputs encoding result information indicating a result of the encoding processing; a management information generating unit which generates management information of the encoding processing based on the encoding result information; a recording unit for recording the bitstream data and the management information to a recording medium; a decoding unit for decoding the bitstream data; a reproduction control unit for controlling the decoding unit based on the management information; and an abnormality detecting unit which detects that recording operation of the recording unit is abnormally ended without performing proper recording.

### BACKGROUND OF THE INVENTION

1. Field of the Invention

The present invention relates to a digital video recording device which is capable of recovering mismatch between stream data and management information caused due to an unexpected and abnormal shutdown of a system, when recording operation and editing operation are performed in a real-time recording device for recording digital video contents, to which a disk recording device such as a hard disk or an optical disk is applied.

2. Description of the Related Art

A recently-spread digital video recording device, to which an optical disk recording device such as a hard disk or an optical disk is applied, digital-converts video/audio information and records the information to a medium by utilizing compression technique. Thereby, it enables to record contents of high image quality and high audio quality in such a form that there is no deterioration thereof caused on the medium.

Further, utilization of these disk recording devices enables to improve the random accessibility to data. Thus, in addition to a function of performing reproduction in order of recording as in a VTR device, it is possible to achieve functions which cannot be achieved by a tape media, e.g. a display function of contents menu, a play list function, etc.

In a typical digital video recording device, in addition to performing processing for recording bitstream data which is obtained by digital-converting and compressing video/audio, it is necessary to know the whereabouts of the bitstream data as a target of processing when performing reproduction/editing, or additional recording of these bitstream data. Therefore, information for managing these contents (referred to as management information hereinafter) is recorded along with the bitstream data.

The bitstream data obtained from inputted video/audio signals mounts from some M bits per second to some tens of M bits. Thus, the bitstream data is recorded to a recording medium successively in order from a generated part.

In the meantime, in a process of generating the bitstream data, information that is necessary for controlling reproduction/editing, e.g. data size of the bitstream data piece, the number of video frames contained therein, the bit rate, etc., is obtained as the management information. The management information is put in a list and necessary items are totalized to be accumulated as a database so that it can be effectively utilized when being referred.

Thus, the management information is accumulated and processed on the memory during recording and it is recorded to a recording medium when the recording is stopped, while the bitstream data is recorded to the recording medium successively. Thus, in the recording medium of the digital video recording device, during recording, normally, there is inconsistency (mismatch) between the information of the bitstream data recorded to the recording medium and the management information thereof. Such a mismatch is generated only in the middle of recording.

However, in the case where the recording stop processing is not properly ended due to a power breakdown or malfunction of the system happened during the recording processing, there is no match between the data on the recording medium. If so, there may be a bad influence imposed upon reproduction processing, editing processing, and additional recording processing to be performed thereafter.

In order to overcome this problem, for example, in Japanese Patent Unexamined Publication 2002-84498 (referred to as Related Art 1 hereinafter), information for recovering management information regarding the contents that are being recorded to a recording medium are accumulated in a volatile memory successively, and the accumulated information is backed up regularly to a nonvolatile memory device for achieving recovery.

Further, in Japanese Patent Unexamined Publication 2000-307987 (referred to as Related Art 2 hereinafter), an auxiliary power source is driven when a main power source becomes incapable of supplying power, the necessary recovery information is recorded to a recording medium during a period where the auxiliary power source is available, and the device is safely shut down.

However, Related Art 1 requires a nonvolatile memory device for regularly backing up the recovery information, thereby increasing the cost for the device. Further, it is necessary to extend the interval of the backup operation from about several minutes to ten minutes considering the life/property of the nonvolatile memory device. Therefore, the recording length (time) of the data revived at the time of recovery can be set only to a point that is traced back from the start point of power breakdown for the length of the interval of the above-described backup operation (from about several minutes to ten minutes) In addition, there is a limited life in the currently-distributed nonvolatile memory devices based on the number of rewriting. Form a viewpoint of maintaining the life of product, there is a restriction in the backup frequency of the recovery information.

Related Art 2 requires an additional auxiliary power source, so that the cost for the device is increased as in Related Art 1. Further, the recovery information cannot be retracted when the system is shutdown abnormally due to a reason other than malfunction of power source. Thus, it is difficult to recover the recorded data.

### SUMMARY OF THE INVENTION

The main object of the present invention therefore is to make it possible to record the recovery data during recording processing to another area of the recording medium, or to the recording medium in the same area as that for recording the contents by multiplexing the recovery data on the bitstream.

In order to overcome the aforementioned problems, the digital video recording device of the present invention comprises: an encoding unit which generates bitstream data by performing encoding processing on recording-target video/audio signals and outputs encoding result information indicating a result of the encoding processing; a management information generating unit which generates management information of the encoding processing based on the encoding result information; a recording unit for recording the bitstream data and the management information to a recording medium; a decoding unit for decoding the bitstream data; a reproduction control unit for controlling the decoding unit based on the management information; and an abnormality detecting unit which detects that recording operation of the recording unit is abnormally ended without performing proper recording.

With the present invention, when the abnormality detecting unit detects that there is abnormality happened and the device is shutdown, various recovering operations can be executed based on the detected result.

As a specific structure for achieving the recovering operation, the present invention comprises: a recovery data generating unit for generating recovery data that is necessary for recovering from abnormality when the abnormality detecting unit detects the abnormality; and a management information recovery unit for recovering the management information. The recording unit records the recovery data, which is generated by the recovery data generating unit, to the recording medium that is the same recording medium for the bitstream data and the management information, which are recovery targets of the recovery data, and the management information recovery unit recovers the management information by reading out the recovery data from the recording medium when the abnormality detecting unit detects generation of abnormality.

With this, the recovery data can be recorded on the same recording medium as that of the bitstream data and the management information, which are the recovery targets of the recovery data, and the disk can be recovered based on the recovery data when the device is abnormally shut down.

As recording structure of the recovery data according to the present invention, there is described a following structure. In this structure, the recovery data generating unit generates the recovery data by performing totalization processing on the encoding result information, and the recording unit records the recovery data to the recording medium in a file which is different from that of the bitstream data and the management information.

Further, as another recording structure of the recovery data according to the present invention, there is described a following structure. In this structure, the recording unit records the recovery data to the recording medium in the same time series as that of the bitstream. Recording the data in the same time series means to perform recording of the data in a physically continuous manner or to record the data to a logically adjacent area so that there is no seeking action and the like of the pickup to be generated.

Conventionally, it has been necessary to retract the recovery data using additional components such as a nonvolatile memory device and auxiliary power source. However, the present invention does not require those additional components so that it enables to cut the cost for system components. Further, the present invention enables to improve the reproducibility by recovery since it is unnecessary to restrict the backup frequency of the recovery information due to the life of the nonvolatile memory device. Furthermore, present invention employs the method for multiplexing the recovery information on the bitstream. Therefore, it enables to recover the data by going back to almost the same point where the abnormal shutdown happened. Thus, the reproducibility by the recovery processing can be more improved.

The digital video recording device according to the present invention can be most effectively utilized as a product in a field of AV equipment used especially in people's livelihood. Since the number of components can be reduced, the effect of cost cut in mass-production is considered to be significant. Moreover, the reproducibility of the data by the recovery processing performed after the abnormal shutdown is high, so that it is expected to improve the convenience.

Other objects of the present invention will become clear from the following description of the preferred embodiments and the appended claims. Those skilled in the art will appreciate that there are many other advantages of the present invention possible by embodying the present invention.

### BRIEF DESCRIPTION OF THE DRAWINGS

FIG. 1 is a block diagram of a typical digital video recording device;

FIG. 2 is an illustration for showing a logic data structure on a recording medium which is provided to a recording unit of the device of FIG. 1;

FIG. 3 is a block diagram of a digital video recording device according to an embodiment of the present invention;

FIG. 4 is an illustration for showing a logic data structure on a recording medium which is provided to a recording unit of the device of FIG. 3;

FIG. 5 is a flow of recording start processing performed by the device of FIG. 3;

FIG. 6 is a flow of in-recording processing performed by the device of FIG. 3;

FIG. 7 is a flow of recording stop processing performed by the device of FIG. 3;

FIG. 8 is a flow of recovery processing performed by the device of FIG. 3;

FIG. 9 is an illustration for showing a logic data structure on a recording medium in a first recovery data recording method;

FIG. 10 is an illustration for showing a logic data structure on a recording medium in a second recovery data recording method;

FIG. 11 is an illustration for showing encoding result information which is outputted for every generation of VOBU;

FIG. 12 is an illustration for showing encoding result information which is outputted for every generation of VOB; and

FIG. 13 is an illustration for showing the structure of recovery data.

### DETAILED DESCRIPTION OF THE PREFERRED EMBODIMENTS

A digital video recording device according to a preferred embodiment of the present invention will be described hereinafter by referring to the accompanying drawings.

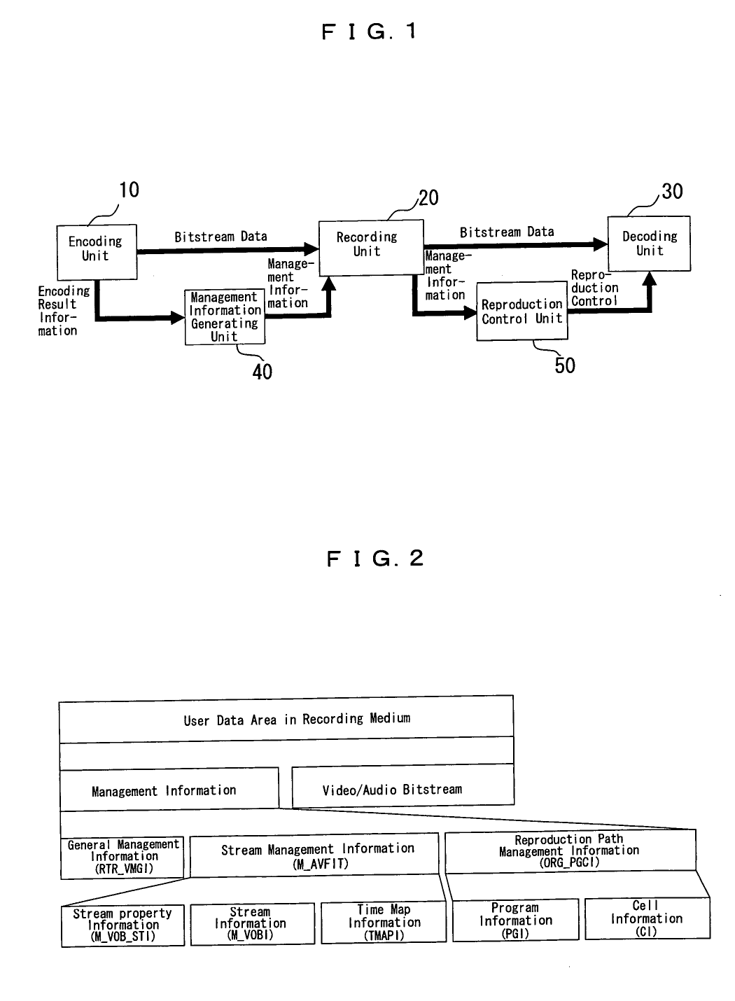

First, before describing the digital video recording device of the embodiment, a typical digital video recording device will be described by referring to FIG. 1 and FIG. 2. FIG. 1 shows the structure of the digital video recording device, and FIG. 2 shows the structure of logic data on a recording medium (not shown) which is provided to a recording unit shown in FIG. 1. In FIG. 1, reference numeral 10 is an encoding unit, 20 is a recording unit, 30 is a decoding unit, 40 is a management information generating unit, and 50 is a reproduction control unit.

At the time of recording, the encoding unit 10 generates bitstream data by digitalizing and compress-processing video/audio signals to be outputted to the recording unit 20. In the meantime, encoding result information of the bitstream data is outputted to the management information generating unit 40. The management information generating unit 40, based on the encoding result information, generates and outputs the management information of the bitstream data that is recorded to the recording unit 20. The recording unit 20 records the bitstream data and the management information to a recording medium such as a DVD-RAM, an HDD, or the like.

For achieving the above-described processing, the management information for managing the bitstream data is required additionally. The management information is control information for recording the bitstream data on the recording medium of the recording unit 20 and for performing reproduction, additional recording, and editing thereof.

There is described a user data area on the recording medium by referring to FIG. 2. The user data area contains the management information and the video/audio bitstream. The management information contains regular management information (RTR_VMGI), stream management information (M_AVFIT) for managing the bitstream data, and reproduction path management information (ORG_PGCI) for managing the reproduction path. The stream management information (M_AVFIT) contains stream property information (M_VOB_STI), stream information (M_VOBI), and time map information (TMAPI). The reproduction path management information (ORG_PGCI) contains program information (PGI) and cell information (CI).

As the encoding result information regarding the bitstream data that is to be outputted, the encoding unit 10 outputs the property information of the video/audio signals of the bitstream, time information of the video/audio contained in the outputted bitstream data, size information of the outputted bitstream data, and search information.

The property information is the video aspect ratio, video horizontal resolution, video vertical resolution, audio stereo mode, etc. The time information of video/audio is the number of video fields, time reference information, output timing, etc.

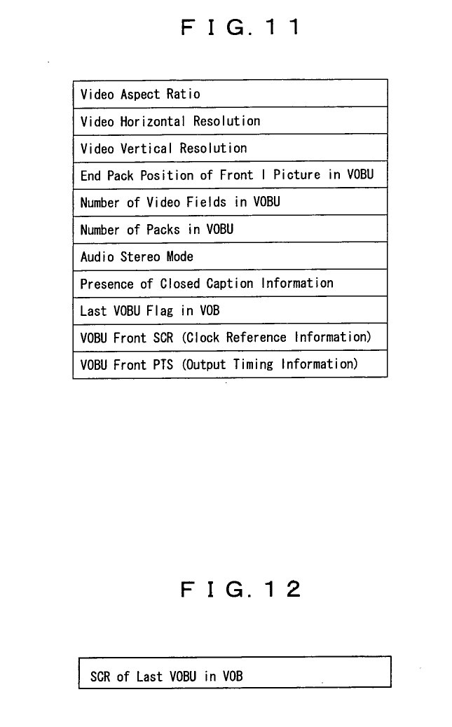

When DVD video recording standard is employed as an installing format, information items as shown in FIG. 11 and FIG. 12 are required. The management information generating unit 40 generates the management information shown in FIG. 2 by using the encoding result information regarding the bitstream data. The bitstream data outputted from the encoding unit 10 is transferred to the recording unit 20 every time when it is generated, and recorded to the recording medium successively. In the meantime, the contents of the management information outputted from the management information generating unit 40 are determined while the recording processing is stopped, and the determined management information is transferred to the recording unit 20 to be recorded to the recording medium.

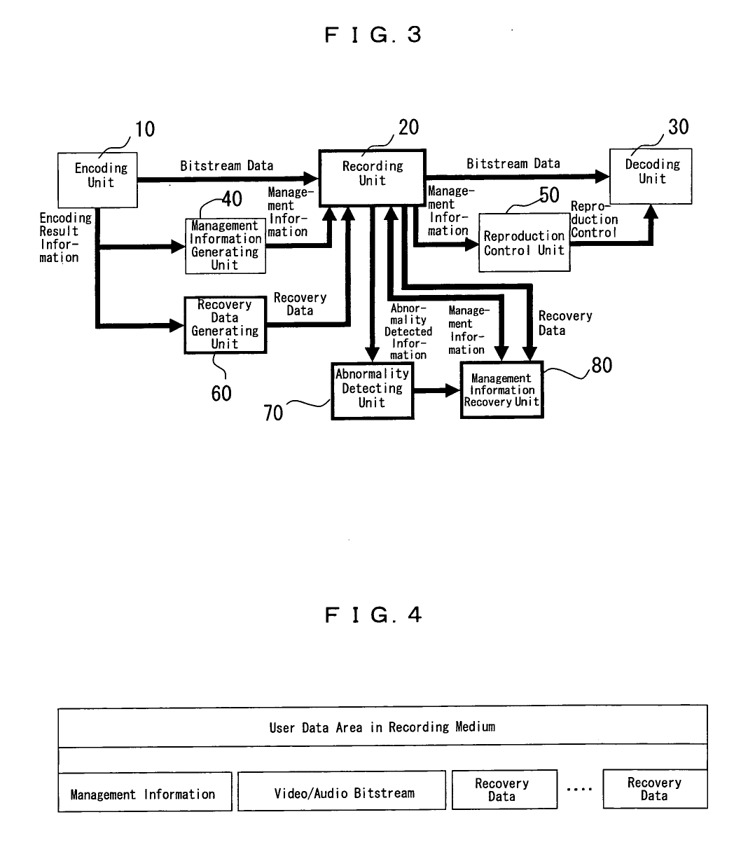

Next, the digital video recording device according to the embodiment of the present invention will be described by referring to FIG. 3 and FIG. 4. FIG. 3 shows the structure of this digital video recording device, and FIG. 4 shows the structure of the data on a recording medium that is provided to the recording unit of the digital video recording device of FIG. 3.

The device of the embodiment comprises a recording function for performing recording to the recording medium based on inputted video/audio signals, a recovery function that recovers the bitstream data and the management information, which has turned abnormal on the recording medium when the device is abnormally shut down during recording, and a reproduction function which reproduces contents by utilizing the bitstream and the management information, which are recorded to the recording medium. As the structural elements for achieving these functions, the device of the embodiment comprises an encoding unit 10, a recording unit 20, a decoding unit 30, a management information generating unit 40, a reproduction control unit 50, a recovery data generating unit 60, an abnormality detecting unit 70, and a management information recovery unit 80.

The aforementioned structural elements will be described in detail. The device of the embodiment comprises, as the structure for achieving the recording function: the encoding unit 10 which digitalizes and encodes the inputted video/audio signals; the management information generating unit 40 which generates the management information of the contents based on the encoding result information outputted from the encoding unit 10; the recovery data generating unit 60 which generates the recovery data based on the encoding result information outputted from the encoding unit 10; and the recording unit 20 which records, to a recording medium, the bitstream data generated by the encoding unit 10, the management information generated by the management information generating unit 40, and the recovery data generated by the recovery data generating unit 60.

The device of the embodiment comprises, as the structure for achieving the recovery function: the abnormality detecting unit 70 for detecting that the device is shut down abnormally during recording; and the management information recovery unit 80 for recovering the bitstream data and the management information, which are recorded to the recording medium by the recording unit 20, by using the recovery data generated by the recovery data generating unit 60 when the abnormal shutdown of device is detected by the abnormality detecting unit 70.

The device of the embodiment comprises, as the structure for achieving the reproduction function: the reproduction control unit 50 for controlling the reproducing operation by using the management information recorded to the recording medium; and the decoding unit 30 which decodes the video/audio signals by decoding the bitstream data that is recorded to the recording medium according to the control of the reproduction control unit 50.

The encoding unit 10 operates during recording for digital-converting the inputted video/audio signals, and performs compression processing by a system that is required for the recording system. For example, if it is to comply with the DVD standard, the encoding unit 10 generates and outputs the bitstream of MPEG2-PS format. When encoding, the encoding unit 10 outputs the encoding result information regarding the encoded and outputted bitstream. The encoding result information, if complied with the DVD standard, contains the property information and time information of the contents, information on the size of the bitstream data of the encoding result, and the like, for example, as shown in FIG. 11 and FIG. 12. Further, in the DVD standard, there is a unit referred to as VOB (video object) in the bitstream, which contains a series of recording contents. In addition, there is a minimum access unit referred to as VOBU (video object unit) present in the VOB. Based on this, as the encoding result information, the encoding unit 10 outputs VOBU information every time encoding of VOBU is completed and outputs VOB information every time encoding of VOB is completed, respectively, in accordance with the bitstream to be outputted.

The management information generating unit 40 reads out the existing management information, and performs decompression processing for enabling to perform editing operation. This processing is carried out in advance for grasping the previously recorded state on the recording medium before starting the recording operation. When the recording processing is started, the management information generating unit 40 also generates the property information of the already-recorded bitstream data, the address/size information, time information, search information, reproduction path information, and the like based on the encoding result information outputted from the encoding unit 10.

If it is to comply with the DVD video recording standard, it should correspond to the information that belongs to the stream management information and the reproduction path management information shown in FIG. 2. The management information generating unit 40 updates the management information based on the encoding result information that is informed from the encoding unit 10 during recording, and requests to record the management information to the recording unit 20 when the recording is stopped.

The recovery data generating unit 60 requests setting of data mismatch flag to the recording unit 20 at the time of starting the recording processing. The recovery data generating unit 60 extracts the differential data of modification information that is added to the management information based on the encoding result information informed from the encoding unit 10. As a data extraction method, there are two methods proposed in the embodiment. The recovery data generating unit 60 generates the modification information in accordance with the editing of the management information, which is performed by the management information generating unit 40 every time the encoding result information is informed.

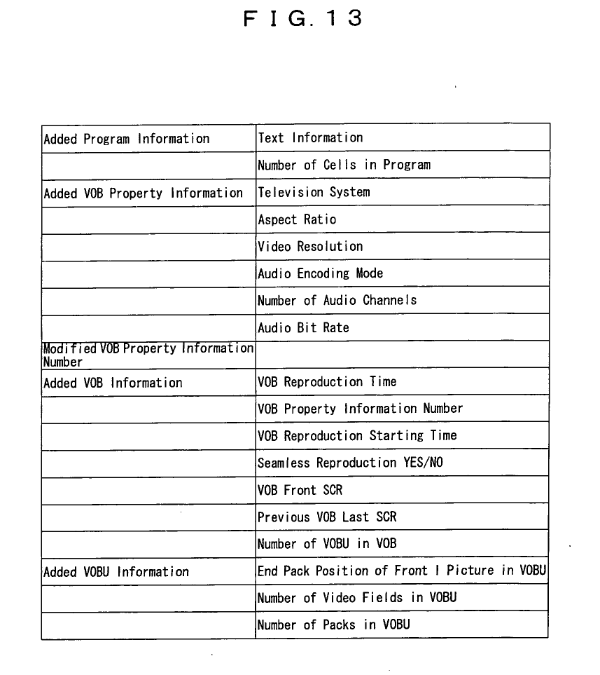

The first method (referred to as a first recovery data recording method hereinafter) is a method which integrates the modification information for the management information into a single data structure. With this, the data is collected at a single place so that the recovery processing is simplified. If it is to comply with the DVD video recording standard, accumulated is the information which corresponds to the added difference of original program information generated during recording, added difference of VOB property information, modification difference of the existing VOB property information, added difference of VOB information, and added difference of VOBU entry among the time map information, as in a table shown in FIG. 13.

The second method (referred to as a second recovery data recording method hereinafter) is a method which generates the modification information for the management information as a piece of data to be the modification differential information for each time. In this method, the recovery data is encoded by the encoding unit 10 simultaneously with the recording of the bitstream by time division to be recorded by the recording unit 20. That is, the recovery data is recorded to the recording medium in the same time series as that of the bitstream.

If it is to comply with the DVD video recording standard, added difference of the original program information, added difference of the VOB property information, modified difference of the existing VOB property information, and the added difference of the VOB information are collectively stored and recorded to the recording medium in addition to the bitstream property information, VOBU reproduction time, VOBU data size, SCR information, and PTS information, as shown in FIG. 11 and FIG. 12, which can be obtained from the VOBU information that is outputted every time the VOBU is generated by the encoding unit 10. If it is to comply with the DVD video recording standard, a piece of the recovery data may be written to an MNFI area of an RDI pack. Further, for improving the processing efficiency of the recovery processing, the differential information of the address may be contained in the recovery data as the search information of the RDI pack that is to be appeared next. The recovery data generating unit 60 requests resetting of data mismatch flag to the recording unit 20 at the time of performing recording stop processing.

Operation of the recording unit 20 will be described. At the time of starting the recording, the recording unit 20 receives a request for setting data mismatch flag from the recovery data generating unit 60, and sets the data mismatch flag in a managing area of the recording medium. The recording unit 20 records the bitstream data outputted from the encoding unit 10 to the recording medium in real-time, and informs the recording address information on the medium to the management information generating unit 40.

In the case of employing the first recovery data recording method, the recovery data which is regularly generated by the recovery data generating unit 60 is recorded to the recording medium. At this time, it is recorded by time division with recording of the bitstream data. A recovery data file area is additionally and fixedly secured for recording the recovery data therein. In that case, there may be a plurality of recovery data file areas secured so as to be used cyclically. Also, without fixedly securing the recovery data file area, it may be in a form in which the recovery data file area may be disposed alternately with the recording area of the bitstream data and a priority is given to the writing function.

In the case of employing the second recovery data recording method, the recording unit 20 stores a piece of recovery data, which is generated in the recovery data generating unit 60 every time VOBU is generated in the encoding unit 10, in the MNFI block of the RDI pack within the bitstream data that is outputted from the encoding unit 10, and records it to the recording medium. In that case, the recovery data file area becomes unnecessary.

At the time of stopping the recording, the recording unit 20 receives a request for resetting the data mismatch flag from the recovery data generating unit 60, and resets the data mismatch flag in the managing area of the recording medium.

The abnormality detecting unit 70 requests, to the recording unit 20, to check the data mismatch flag on the recording medium at the time of starting up the device. When detecting that the data mismatch flag is being reset, the abnormality detecting unit 70 judges that the last shutdown was carried out properly, thereby performing no recovery processing. In the meantime, when detecting that the data mismatch flag is being set, the abnormality detecting unit 70 judges that the device was shut down abnormally during the recording operation, thereby requesting to start the recovery processing to the management information recovery unit 80. The abnormal shutdown in this case may be the state where the device is shut down without properly recording the information generated by the encoding unit 10 or the management information generating unit 40, for example.

The management information recovery unit 80 receives the information indicating that the last shutdown was abnormal, which is detected by the abnormality detecting unit 70, and obtains the recovery information from the recording medium through the decoding unit 30.

In the case where the recovery data is recorded by the first recovery data recording method, the management information recovery unit 80 can obtain the recovery data as a single file. Thus, the management information recovery unit 80 requests to obtain the recovery data file to the recording unit 20. In accordance with the request, the recording unit 20 sends the recovery data file to the management information recovery unit 80. The management information recovery unit 80 performs update processing again, which is the same as the processing performed on the management information at the time of previous recording, on the received recovery data file for generating the normal management information and transmits it to the recording unit 20. The recording unit 20 records the received management information.

In the case where the recovery data is recorded by the second recovery data recording method, the recovery data is dispersedly recorded in the bitstream file. In that case, the management information recovery unit 80 collects the recovery information in the RDI pack by scanning from the front position of the previous recording so as to obtain the recovery data which corresponds to the file to be obtained from the recovery data that is recorded by the first recovery data recording method. At this time, if there is search information of the following RDI pack recorded in the present RDI pack, searching may be more effectively performed by using the search information.

Recovery of the management information is carried out by using the recovery data which can be obtained through the above-described manner. For recovery of the management information and verification of the consistency of the bitstream data, it is possible to use a method disclosed in Japanese Patent Unexamined Publication 2002-84498, for example.

With this, as shown in FIG. 4, the recording unit 20 records, on the recording medium, the management information and a plurality of recovery data (recovery data files) which are different from the video/audio bitstream data. The management information and the video/audio bitstream of FIG. 4 are the same as those of FIG. 2, so that FIG. 2 and the description thereof should be referred to for the details.

The recovery data recording method of the embodiment will be described in more detail. In the first recovery data recording method, the recovery data generating unit 60 generates the recovery data after performing totalization processing on the encoding result information that is informed from the encoding unit 10. The recording unit 20 records the recovery data on a file which is different from the file of the bitstream data and the management information.

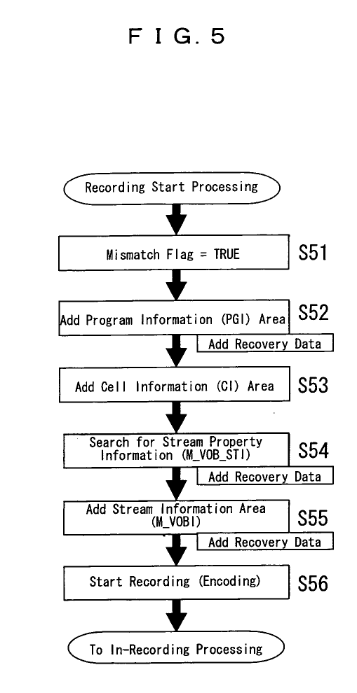

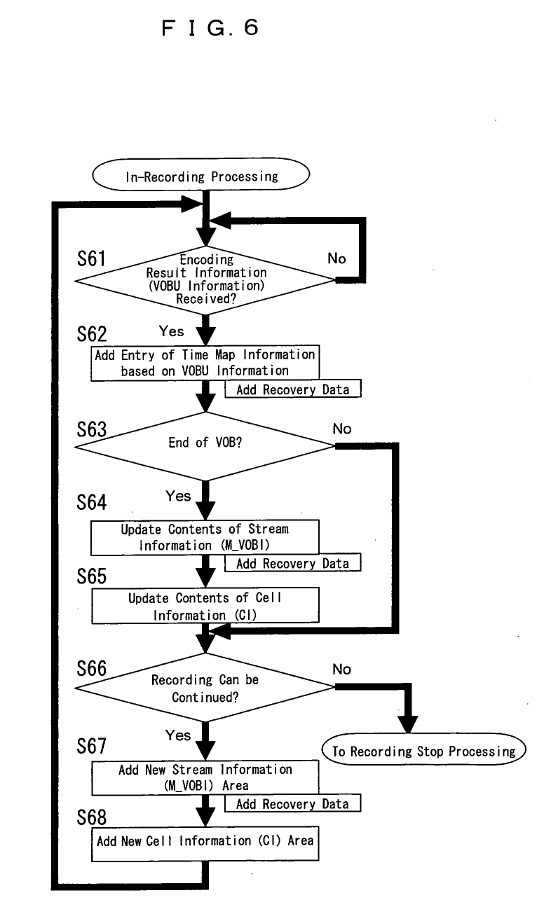

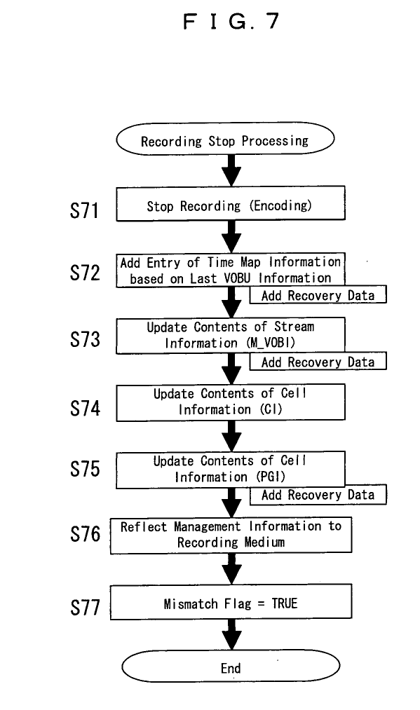

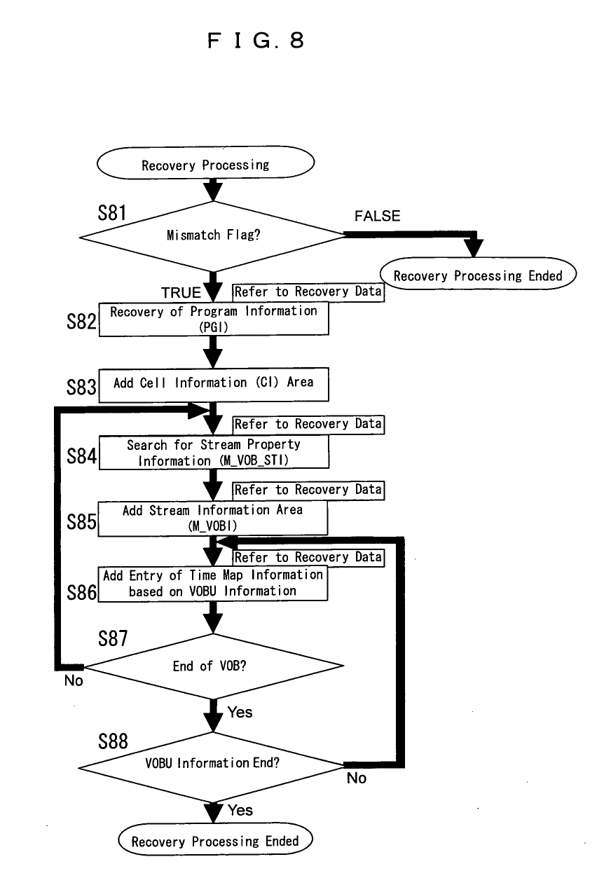

FIG. 5 shows a flow of the recording start processing of the embodiment, FIG. 6 shows a flow of in-recording processing, FIG. 7 shows a flow of recording stop processing, and FIG. 8 shows a flow of recovery processing. For performing data processing of the recording processing, it is necessary to generate the management information of FIG. 4, specifically, the management information as shown in FIG. 2 based on the encoding result information that is outputted from the encoding unit 10. The management information is classified into general management information, stream management information, and reproduction path management information.

The stream management information is classified into: stream property information which contains the property information of the video/audio signals in the bitstream; stream information which contains the information regarding recording/reproduction time information of the bitstream and the information regarding the connectivity (continuity) of the bitstream at the time of reproduction; and time map information which contains time search information, time information/address information for each access unit, etc.

The reproduction path management information is classified into program information which manages a program as a managing unit of contents, and cell information which manages a cell as a unit for indicating the communication path as a part of the program.

At the time of performing the recording start processing, as shown in FIG. 5, the management information generating unit 40 sets (TRUE) a data mismatch flag to the recording medium prior to starting the processing (S51). With this, when the device is shut down abnormally, the flag is kept being set so that the abnormal shutdown can be detected. Thereafter, the management information generating unit 40 newly adds a program information area as the reproduction path information (S52). Further, first cell information is added along therewith (S53). Also, the management information generating unit 40 searches the stream property information which corresponds to the bitstream data to be recorded (S54), and adds a stream information area (S55). After performing the above-described processing, recording (encoding) is started (S56).

In the adding processing of the data, the data in regards to adding the program information area, the data regarding the search result of the stream property information, and the data in regards to adding the stream information area may be considered as the recovery data. The recovery data generating unit 60 collects these recovery data on the memory.

For recording, as shown in FIG. 6, the management information generating unit 40 receives the encoding result information (VOBU information) from the encoding unit 10 (S61), and executes the entry adding processing of the time map information base on the VOBU information (S62). If it is an end of the stream (end of VOB) (S63), update of the stream information contents is performed (S64) and update of the cell information contents is performed (S65). Thereafter, if the recording can be continued (S66), a new stream information area is added (S67) and a new cell information area is added (S68).

In the adding processing of the data, the data regarding the additional entry information of the time map information, the data regarding the update contents of the stream information, and the data in regards to adding the new stream information area may be considered as the recovery data. The recovery data generating unit 60 collects these pieces of information on the memory.

During recording, it is necessary to record the recovery data, which is accumulated through the above-described processing, to the recording medium regularly. Thus, the recovery data generating unit 60 transfers the collected recovery data to the recording unit 20 regularly for requesting, to the recording unit 20, to record the data to the recoding medium. At this time, the recovery data is different information from the bitstream data and the management information on the recording medium. Thus, the recovery data is recorded to the recording medium as the recovery data file in a form that is shown in FIG. 4. At this time, the recovery data file cannot maintain the consistency as the data while writing the recovery data file. Thus, the recovery data file is made manageable by a plurality of generations and those file areas may be used cyclically and continuously.

For stopping the recording (S66), as shown in FIG. 7, the management information generating unit 40 performs recording (encoding) stop processing (S71), entry adding processing of the time map information based on the last VOBU information (S72), update processing of the stream information contents (S73), update processing of the cell information contents (S74), and update processing of the program information contents (S75). Then, after reflecting the management information on the recording medium (S76), the data mismatch flag is set to the recording medium (S77).

In the adding processing of the data, the data regarding the additional entry information of the time map information, the data regarding the update contents of the stream information, and the data in regards to adding the new stream information area may be considered as the recovery data. The recovery data generating unit 60 collects these pieces of information on the memory.

In the recovery processing, as shown in FIG. 8, first, it is judged whether or not the mismatch flag is being set or reset in the recording medium data (S81). When it is judged in the processing of S81 that the mismatch flag is being reset, the recovery processing is ended. When it is judged in the processing of S81 that the mismatch flag is being set, the program information area is recovery-processed by referring to the recovery data (S82), and the cell information is added (S83). Further, the stream property information is searched by referring to the recovery data (S84) and, then, the stream information area is added by referring to the recovery data (S85). Further, the entry of the time map information is added based on the VOBU information by referring to the recovery data (S86). Then, if it is not the end of VOB (S87), it returns to the step (S84) for searching the stream property information by referring to the recovery data. If it is the end of VOB, it is judged whether or not the VOBU information is ended (S88). If the VOBU information is ended, the recovery processing is ended.

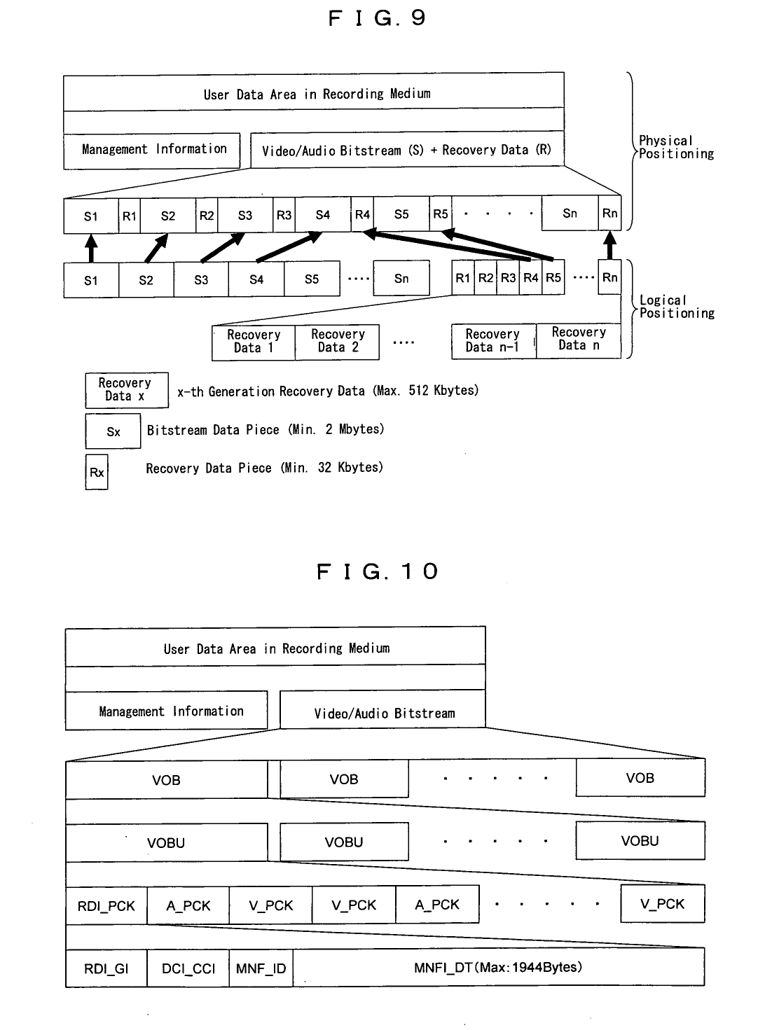

In the case where the recovery data is recorded by the above-described first recovery data recording method, it is preferable to perform recording by alternately disposing the bitstream data and the recovery data in a new continuous area without fixedly securing separate file areas on the recording medium. An example of this arrangement will be described by referring to FIG. 9.

FIG. 9 shows a user data area of the recording medium. The user data area comprises an area to which the management information is stored and an area to which the video/audio bitstream and the recovery data (R) are stored. In the drawing, a piece of the video/audio bitstream is denoted by Sx, a piece of the recovery data is denoted by Rx, and the recovery data of the x-th generation is expressed by the recovery data x. The aforementioned x is a natural number from 1 to n. FIG. 9 shows the physical positioning and logical positioning of each data Sx, Rx, and the recovery data x in the user data area, respectively.

As shown in FIG. 9, the piece Sx of the bitstream data and the piece Rx of the recovery data, which are alternately disposed in a physically continuous area, are transferred to the recording medium. With this, extra sector-jumping of the digital video recording device, which is happened when recording the recovery data n, becomes unnecessary. Thus, it enables to suppress the influence upon the recording property to be the minimum.

For the case where the DVD video recording standard is used as a recording format, let's assume that the minimum size of the bitstream data piece Sx is 2 Mbytes, the minimum size of the recovery data piece Rx is 32 Kbytes, and the maximum recovery data size is 512 Kbytes.

In this case, the data size of the bitstream data to be recorded becomes 32 Mbytes. This data size corresponds to the time length of slightly less than three minutes when converted to the low bit rate (for example, 1536 kbps). That is, the precision of recovery can be estimated to be about three minutes even at the worst. Accordingly, the recovery data can be recorded by the piece of larger size than the minimum size that is defined in the media or format through performing recording to the recording medium by alternately disposing the bitstream data piece and the recovery data piece in the physically continuous area.

Further, in the case where the recovery data and the management information are recorded to the recording medium in completely the same format, and these pieces of data are managed over a plurality of generations, it enables to return the management information on the recording medium to the state of the previous generation in accordance with a request from a user whether the device is shut down abnormally or not. By utilizing this mechanism, it is possible to provide the device with an Undo function. In other words, the recovery data is the same information as the management information which is generated at the time of performing recording to the recording medium. Thus, it is possible to record the already-edited management information to the recording medium as the recovery data at the point where the recording processing or the editing processing is completed and, as necessary, to restore the management information which is of before the execution of the user operations that have been executed by then.

In the above-described second recovery data recording method, there is described a way of recording the recovery data without using another file by multiplexing the recovery data on the bitstream. The digital video recording device achieved by the second recovery data recording method complies with the DVD video recording standard. Therefore, the bitstream data generated in this device has the structure shown in FIG. 10. That is, the bitstream data has a recording unit of VOB, and the VOB has an integer-numbers of access units referred to as VOBU. Further, there is real-time reproduction management information referred to as an RDI pack which is disposed in the front of the VOBU and, thereafter in the VOBU, elementary streams regarding the video, audio, subtitles are multiplexed and disposed.

The maximum reproduction time of the VOBU is one second. In the RDI pack (RDI_PCK) present in the front of the VOBU, a manufacture information block (MNFI_DT) of 1944 bytes at the maximum is disposed as a free (vacant) area.

RDI_PCK is a real-time data information pack, A_PCK is an audio pack, V_PCK is a video pack, RDI_GI is real-time data information general information, DCI_CCI is display control information copy/control information, and MNF_ID is manufacture information data.

In the second recovery data recording method, the encoding result information that is outputted from the encoding unit 10 is outputted every time the VOBU is generated, and every output thereof, it is possible to add data to a fee area of the RDI pack positioned in the front of the VOBU. By utilizing this structure, the differential information that is informed as the encoding result information of the VOBU is recorded to the recording medium along with the VOBU every time the VOBU is outputted without organizing the recovery data as a single file.

By carrying out the above-described processing, it is possible through scanning the recovery data to achieve recovery of the management information in the same manner as that of generating the management information performed in the first recovery data recording method. That is, since the digital video recording device of the embodiment complies with the DVD video recording standard, the recovery data generating unit 60 generates the recovery data without performing totalization processing of the encoding result information that is informed from the encoding unit 10. Then, the recording unit 20 stores the generated recovery data in a vacant area of the manufacture information block within the bitstream data for recording the recovery data on the bitstream file.

The embodiment enables to record the encoding result information to this RDI pack and, at the same time, to record the address of the next RDI pack or the number of sectors of the next RDI pack by using the size information of the corresponding VOBU. In that case, it is necessary to scan those RDI packs at the time of performing recovery processing. However, by utilizing the address information, it is possible to improve the speed of performing the recovery processing by searching only the RDI packs in order but not scanning all the packs of the bitstream.

Further, the device of the embodiment can be operated to start recording of a new program without reading out the management information that has been recorded so far at the time of staring up the device. Thereby, the time required from the startup of the device to the start of recording can be shortened. When the recording is started in this method, the management information can be generated at the time of stopping the recording by performing the same processing as the recovery processing performed in the device.

The present invention has been described in detail by referring to the most preferred embodiments. However, various combinations and modifications of the components are possible without departing from the sprit and the broad scope of the appended claims.

What is claimed is:

1. A digital video recording device, comprising:
an encoding unit which generates bitstream data by performing encoding processing on recording-target video/audio signals and outputs encoding result information indicating a result of said encoding processing;
a management information generating unit which generates management information of said encoding processing based on said encoding result information;
a recording unit for recording said bitstream data and said management information to a recording medium;
a decoding unit for decoding said bitstream data;
a reproduction control unit for controlling said decoding unit based on said management information; and
an abnormality detecting unit which detects that recording operation of said recording unit is abnormally ended without performing proper recording.

2. The digital video recording device according to claim 1, further comprising:
a recovery data generating unit for generating recovery data that is necessary for recovering from abnormality when said abnormality detecting unit detects said abnormality; and
a management information recovery unit for recovering said management information, wherein
said recording unit records said recovery data, which is generated by said recovery data generating unit, to said recording medium that is a same recording medium for said bitstream data and said management information, which are recovery targets of said recovery data, and
said management information recovery unit recovers said management information by reading out said recovery data from said recording medium when said abnormality detecting unit detects generation of said abnormality.

3. The digital video recording device according to claim 2, wherein
said recovery data generating unit generates said recovery data by performing totalization processing on said encoding result information, and
said recording unit records said recovery data to said recording medium in a file which is different from that of said bitstream data and said management information.

4. The digital video recording device according to claim 2, wherein said recording unit records said recovery data to said recording medium in a same time series as that of said bitstream.

5. The digital video recording device according to claim 4, which complies with DVD video recording standard, wherein
said recovery data generating unit generates said recovery data without performing totalization processing on said encoding result information, and
said recording unit stores said recovery data in a vacant area of a manufacture information block in an RDI pack within said bitstream data when recording said recovery data to said recording medium.

6. The digital video recording device according to claim 3, wherein
when recording said recovery data, a piece of said bitstream data and a piece of said recovery data are alternately disposed in a physically continuous area on said recording medium, and sizes of said pieces are set to be larger than minimum sizes that are defined by media or format of said recording medium.

7. The digital video recording device according to claim 3, wherein
said recovery data generating unit generates said recovery data which is same as said management information that is generated at the point where recording is performed to said recording medium,
at a point where recording processing or editing processing is completed, said recording unit records said management information, which is completely edited, to said recording medium as said recovery data, and
said management information recovery unit restores, as necessary, said management information which is of before execution of user operations that have been carried out by then.

8. The digital video recording device according to claim 5, wherein said RDI pack for storing said recovery data stores address of next RDI pack or number of sectors to said next RDI pack.

9. The digital video recording device according to claim 5, wherein
for starting up a system, recording processing is started without performing reading-out and analyzing processing of said management information that is recorded to said recording medium,
when performing recording processing, said encoding result information outputted from said encoding unit is used as it is as recovery information, and
when performing recording stop processing, said management information is generated based on said recovery information accumulated on said recording medium.
